(19) United States
(12) Patent Application Publication
(10) Pub. No.: US 2008/0022294 A1
(43) Pub. Date: Jan. 24, 2008

(54) Matching users with wirelessly downloaded video and audio content

(76) Inventors: Stephen L. Perrin, King county, WA (US); William A. Hodgman, King County, WA (US)

Correspondence Address: JAMES L. DAVISON, 19822 226TH AVENUE N.E., WOODINVILLE, WA, 98077, US

(21) Appl. No.: 11/880,128

(22) Filed: Jul. 21, 2007

Related U.S. Application Data
(60) Provisional application No. 60/832,408, filed on Jul. 21, 2006.

(51) Int. Cl. H04N 7/16; H04H 7/00; H04N 7/14

(52) U.S. Cl. 725/9; 348/14.02; 455/3.06; 455/41.2; 725/62; 348/E07.001; 348/E07.077; 348/E07.078; 348/E07.079

(57) ABSTRACT

Current technology now allows wireless handheld devices the capability of receiving broadcast video and audio. To determine who is watching and who is listening to such broadcasts a different type of metering methodology is needed. This invention relates to gathering, transmitting, storing and analyzing who is watching or listening to a particular video or audio broadcast and then matching this information to a particular demographic to which the watcher or listener belongs.

### CROSS-REFERENCE TO RELATED APPLICATIONS

This application claims the benefit of provisional patent application Ser. No. 60/832,408 filed Jul. 21, 2006 by the present inventors.

### BACKGROUND

1. Field

The present invention enables the monitoring of user selections of video and audio events broadcast to a user's handheld wireless communication device. Specific events are then correlated to the demographic category of the users downloading said events.

2. Description of Related Art

The recent availability of a digital broadcast's demodulator and silicon tuner modules that both use low power, and are now small enough to use in handheld devices, have made reception of broadcast video and audio a reality. There is a now a need to be able to monitor which broadcasts are being viewed and listened by the users of handheld wireless communication devices employing this technology. Devices such as cell phones, Internet equipped PDA's, handheld game modules, and handheld computers are all capable of being equipped to receive broadcast video and audio. Until now the problems with power consumption, performance, size required and antenna diversity needed to receive signals have prohibited usage of quality video reception in small battery powered handheld wireless communication devices. These problems have been solved and there is now a need for the broadcasters of the video and audio to know who is watching and listening, what they are watching and listening to, and when they are watching and listening. For fixed television sets there are a number of ways to determine the audience. There are set-top boxes that may be installed to record what shows are watched. There are also phone surveys where pollsters query the household on what shows are watched, but until the present invention there has not been a way to determine the viewing and listening habits of those using handheld wireless devices to receive video and audio broadcasts. The present invention not only collects what video and audio is being viewed and listened to, but also correlates that information with a user's ID. The user's ID information then allows matching of what is being watched with the user's particular demographic.

### OBJECTS AND ADVANTAGES

Accordingly several objects and advantages of the present invention are: the ability for broadcasters to determine who and what broadcast video and audio their audience is viewing and listening to; the ability to wirelessly send that data, at a predetermined interval, to a remote data collection server; and the ability to match up the data received with the already determined demographic of the viewer. This results in the ability of the user of the present invention to determine the watching habits of the viewer and, if the viewer is using a communication device that allows the viewer to receive messages, then the viewer may be sent a list of upcoming events the viewer may be interested in, along with targeted commercial messages that the viewer's demographic data implies interest in. This allows an advertiser to match the actual viewer and listener demographic to the targeted demographic. This then allows an advertiser the flexibility to change the content of the advertising, or to redirect the advertising to different broadcast content, among other possible actions.

### SUMMARY

In accordance with the present invention a method to collect information as to which video or audio broadcast signal is being watched or listened to, by a user tuning a wireless handheld device, from a plurality of broadcast signals available. Then collecting information concerning the specific broadcast signal selected by the user, storing said information in a database contained within said wireless handheld device, tagging said stored information with an identification code uniquely identifying said user, then transmitting said stored information wirelessly to a remote information collection server. The information is then correlated to a previously determined demographic segment of the users.

### DETAILED DESCRIPTION OF THE PREFERRED EMBODIMENT

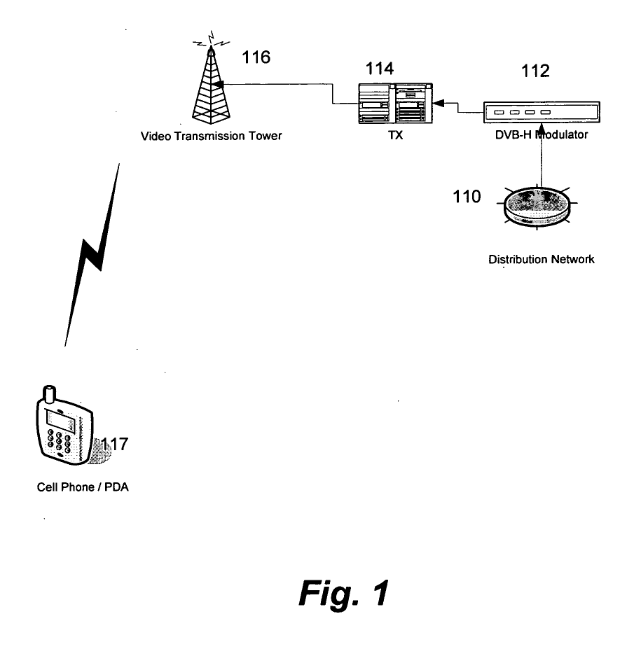

FIG. 1 shows the handheld mobile wireless video receiver within the reception zone of a video transmission tower. The receiver, when activated, notifies the user that a signal of sufficient strength is in the vicinity of the receiver. The receiver, if moving, can transfer its reception signal from the tower that is transmitting the current video data, to a tower transmitting the same video data moving signal that is moving into the range of the video reception device, much like cell phones can receive signals today from cell towers that become into range and out of range. Digital video content and digital audio content may be considered equivalent with regard to the disclosure of the present invention. The distribution network 110 could be a satellite, a microwave network or a terrestrial line as examples. The DVB-H modulator/demodulator 112 removes the digital data from the carrier wave. The TX link 114 is the full-duplex microwave link used to send the DVB signal to the tower through a line-of-sight transmission.

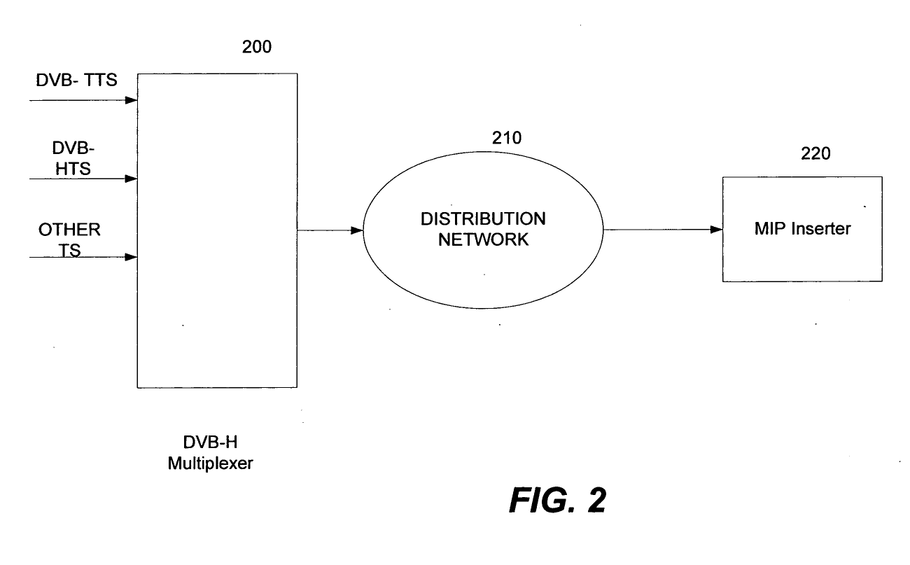

FIG. 2 shows the components making up one embodiment of Digital Video Broadcast—Handheld (DVB-H) architecture. The DVB-H multiplexer 200 can take multiple signals from DVB-TTS (Digital Video Broadcast—Terrestrial Transport Stream), DVB-HTS (Digital Video Broadcast—Handheld Transport Stream) or other TS (Transport System). It then multiplexes the signals and sends them to the Distribution Network 210 and then to the SFN (Signal Frequency Network) MIP (Mega-frame Initialization Packet) Inserter. The SFN MIP inserter is slaved to a 10 MHz/1 pps GPS signal. The SFN forms a mega-frame, consisting of 16 TS-packets (Transport Stream) in the 4 K DVB-H carrier mode and inserts a Mega-frame Initialization Packet (MIP) with the STS parameter to identify the start of the mega-frame M+1. The MIP insertion is needed for the DVB-H time-slicing mechanism.

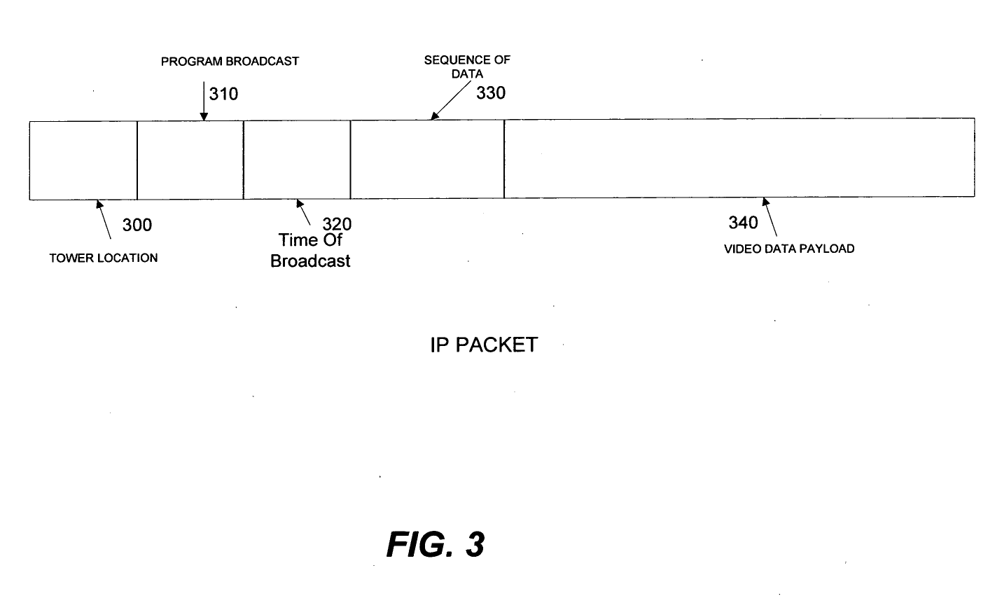

FIG. 3 illustrates the IP signal encapsulating the location of the tower 300, the particular program broadcast 310, the time of the broadcast 320, the data sequence 330, and the video payload 340. This is just an example of the type of data that may be included in the UDP packet. Other information may also be included. The IP packet uses the User datagram Protocol (UDP) and Real time protocol that is encapsulated in a MPE (Multi-protocol encapsulation) packet and then fragmented into TS (transport stream) packets.

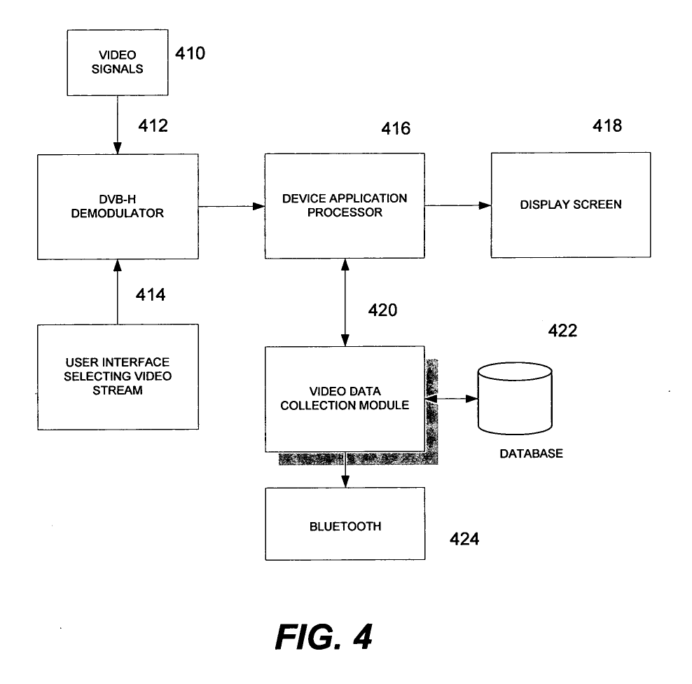

FIG. 4 shows the data collection module parsing the data received with the video signal. The video signal 410 is received by the device antenna whereupon it is routed to the device's VDB-H Demodulator 412. The output of the DVB-H demodulator is an IP stream that is sent to the wireless device's application processor. The device user selects the video to watch by the User Interface 414 whereupon the appropriate signal is routed to the application processor 416 and display screen 418. The data, that is of interest to be collected, is split off from the video payload and sent to the data collection module 420 and stored into the database 422 for later transmission to the remote master data collection server.

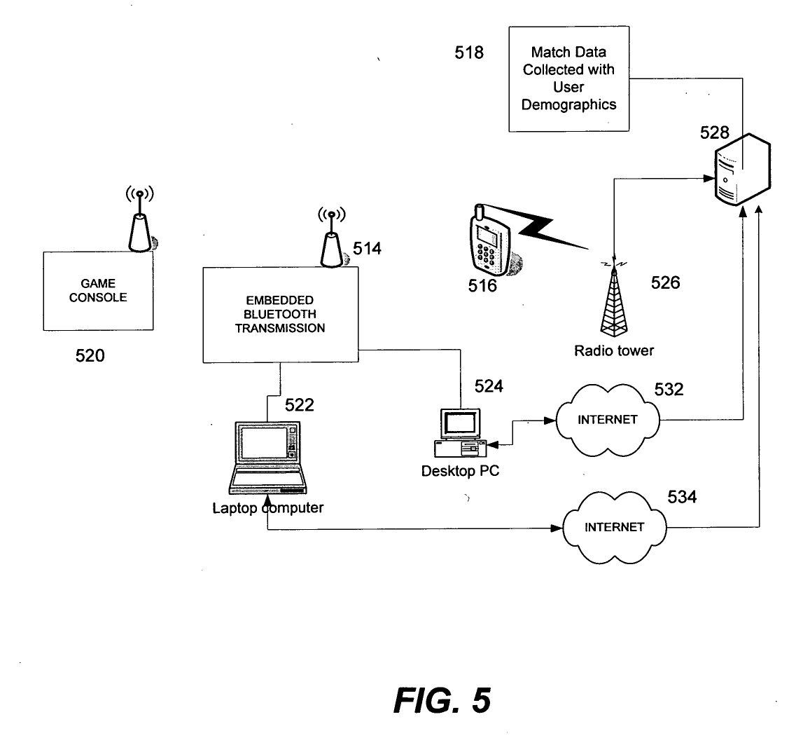

FIG. 5 shows how the information collected may be transmitted to the remote data collection server. If the video receiving device has no long range radio capability for transmission itself (such as a game console 520) it may use a Bluetooth module 514 to connect to a device such as a desktop PC 524 or laptop computer 522 with said long range transmission capability, such as connected to the Internet 532 and 534 through a Wi-Fi network, phone modem, or DSL line. Or the Bluetooth module of the device such as a game console may connect through a cell phone or cell phone enabled PDA device capable of receiving Bluetooth signals. If the device does have a long range transmission capability (such as a cell phone or phone enabled PDA 516) then the device may connect directly to the cell tower 526. The information collected is sent back to a data collection server 528 for analysis and match to demographic 518.

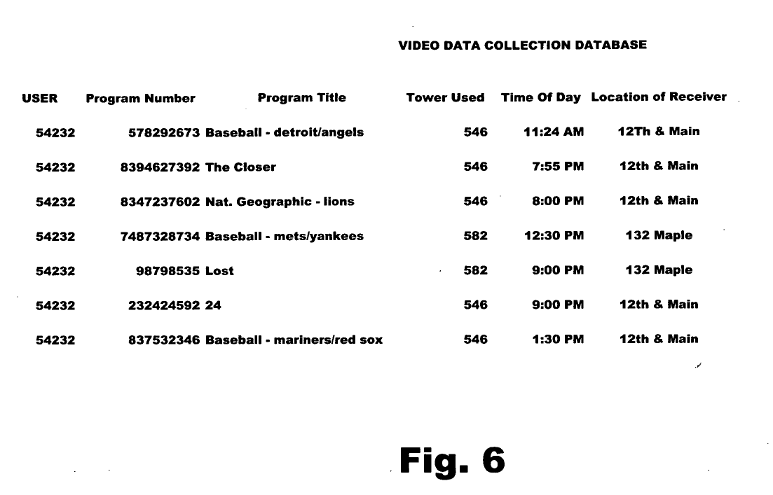

FIG. 6 shows an example database that may be collected from the user's actions. It identifies the user so the user's demographic data that has been previously collected may be correlated to the user's preference in viewing the broadcast video stream.

Examples of the current technology are handsets based on the Windows Mobile 5.0 platform, these handsets are optimized to receive and playback DVB-H mobile broadcasts using Windows Media technologies, including Windows Media Video and Windows Media Digital Rights Management. The handset also uses Windows Media Player 10 Mobile to playback video and music stored in multiple formats, with Windows Media Audio (WMA), MP3 and AAC to be the supported file types.

While new handsets are designed to provide TV and digital music experiences to the user, suppliers are also including the telephone features and benefits that consumers expect from a traditional handset. Handsets can utilize quad-band GSM services (850/900/1800/1900 MHz) to provide international communications capabilities. Handsets are also expected to support GPRS/EDGE services, enabling high speed data access and file downloads as well.

At the core of some handsets is a 200 MHz digital processor, which furnishes high performance video and audio capabilities, and facilitates Bluetooth, wireless LAN and other popular mobile device features. The mobile TV architecture includes a DVB-H Demodulator, and a handheld graphics processing unit, all functioning in a single, seamless device compliant with DVB-H open standards.

Design of a handset can include a standard stereo headphone jack, a 1.3 mega pixel camera and a micro-SD expansion card slot that allows the user to add up to 1 gigabyte of memory for storing hundreds of songs, video clips, games, even full length movies. TV broadcasts and other video can be shown on a landscape display at up to 30 frames per second. The device operates on a lithium-ion battery, furnishing projected battery life of up to three hours of TV viewing, four hours of talk time or six days of standby time.

In keeping with the focus on providing a fun and easy-to-use mobile TV experience, the handset can feature an intuitive electronic service guide. The user interface may be modeled after a traditional in-home TV experience. This places control of live video and audio broadcasts—such as national and local news, sports, entertainment and lifestyle content—in the mobile user's hands.

Other systems besides DVB-H includes may Qualcomm's MediaFlo, which the present invention also encompasses. In some countries such as Korea, services exist using DMB (digital multimedia broadcast) and there are proposals for S-DMB (satellite digital multimedia broadcast), which would use a terrestrial repeater network to relay signals from satellites. The handsets designed to receive signals from these technologies may also be easily adapted to record information on the user's preferences.

The IP multiplexing capability embeds incoming Internet Protocol (IP) datagrams into DVB transport packets according to flexible IP filter settings. For each DVB-H elementary stream, the burst mode bit rate can be specified individually, whereas the MPE-FEC code rate is accurately kept at a specified value. To reduce the burst cycles, the IP multiplexing capability provides the ability to specify the maximum number of columns in MPE-FEC frame's application data table. The behavior of the IP encapsulator is controlled either by means of configuration files or using a network transparent remote interface with simple syntax.

The multiplexer is able to handle constant, variable and low latency data streams. Its flexible filter-based editing facilities meet most of the requirements for real time on-the-fly modification of the data streams being multiplexed. It allows the creation of DVB-T streams with DVB-H elementary streams.

In order to support a range of TV content without severely draining the battery or impacting the ability to receive cellular calls, DVB-H uses a technique called “time slicing,” which allows up to 10 hours of TV viewing on a single battery charge. With time slicing, each TV program is broadcast at a different point in time, so, when a user selects a program, the handset only receives that TV signal and can power down in between transmissions of that channel's content.

With time slicing, the terrestrial transmitter is always on, sending different programs that are staggered in time. First it broadcasts program No. 1, then No. 2, then No. 3, up to “n” programs, then the cycle repeats. The receiver knows when its program is being transmitted and is only turned on and receiving during the specific time slice the desired program is being sent.

Since this is broadcast data in the purest sense, it is necessary for the user's device to modify and conform the signal to comply with the specific device's reception parameters such as the screen size.

Although the invention discusses video usage data collection this same invention will also collect data on audio broadcasts being received by the handheld wireless receiver devices including all the video parameters but, instead of which video steam is being watched, the data collection module is collecting which audio streams are being recorded.

Using a handheld wireless receiver with GPS capabilities, the data captured by the monitoring module may also include information as to the location of the handheld device when a particular video/audio stream was selected by the user. The total broadcast network may be a mix of satellite, terrestrial fixed and terrestrial microwave network segments.

A broadcast network device is distinguished from a typical networked communication device, such as a cell phone, because the transmission is in a one-to-many format. Instead of the user using his wireless device to specifically request a particular over the air resource, he is tuning his device to a broadcast resource that is being delivered to whatever device that has tuned into the broadcast. This makes determining what and when the user is watching or listening to different from the other monitoring solutions available for wireless devices, such as monitoring the specific requests (the user using his device to order a particular resource) of users.

One method of obtaining the demographics of a user and linking that demographic to a specific wireless device may be appreciated by reviewing U.S. patent application Ser. No. 11/183,339 filed Jul. 18, 2005. Other methods not presented are applicable to the present invention.

The description of obtaining viewing and listening preferences of a user and correlating those preferences to specific user demographics according to the preferred embodiments of the present invention is merely exemplary in nature and is no way intended to limit the invention or its application or uses. Further, in the above description, numerous specific details for a type of such apparatus are set forth to provide a more thorough understanding of the present invention. It will be apparent, however, to one skilled in the art, that the present invention may be practiced without these specific details. In other instances, characteristics and functions of the well known processes have not been described so as to not obscure the present invention.

We claim:

1. A method to collect a specific broadcast signal containing video and audio data using a wireless handheld device, said specific broadcast signal selected by a user using said wireless handheld device, from a plurality of broadcast signals available, comprising:
a. tuning the wireless handheld device to receive the specific broadcast signal;
b. collecting information from the specific broadcast signal selected by the user;
c. storing said information in a database contained within said wireless handheld device;
d. tagging said stored information with an identification code uniquely identifying said user;
e. transmitting said stored information wirelessly to a remote information collection server; and
f. correlating said tagged stored information to a previously determined demographic segment of the users.

2. The method of claim 1 wherein transmitting said stored information uses an intermediary transmitting device to reach said remote information collection server.

3. The method of claim 2 wherein the intermediary transmitting device uses a Bluetooth protocol.

4. The method of claim 2 wherein the intermediary transmitting device uses a wireless fidelity protocol.

5. A system to collect a specific broadcast signal, using a wireless handheld device, comprising video and audio data, said specific broadcast signal selected by a user using said wireless handheld device, from a plurality of broadcast signals available, comprising:
a. a tuner contained in said wireless handheld device capable of allowing the wireless handheld device to receive the specific broadcast signal;
b. an information collecting module capable of determining the specific broadcast signal selected by the user;
c. a database contained within said wireless handheld device capable of storing said information;
d. an identification code, attached to said stored information, uniquely identifying said user;
e. a transmitter capable of sending said stored information wirelessly to a remote information collection server; and
f. a correlation matrix associating said stored information, uniquely identifying said user, to a previously determined demographic segment of the users.

6. The system of claim 5 wherein transmitting said stored information uses an intermediary transmitting device to reach said remote information collection server.

7. The system of claim 6 wherein the intermediary transmitting device uses a Bluetooth protocol.

8. The system of claim 6 wherein the intermediary transmitting device uses a wireless fidelity protocol.
